(19) United States
(12) Patent Application Publication
(10) Pub. No.: US 2008/0065666 A1
(43) Pub. Date: Mar. 13, 2008

(54) Apparatuses, data structures, and methods for dynamic information analysis

(75) Inventors: Stuart J. Rose, Richland, WA (US); Gary R. Danielson, Kennewick, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, a part interest, Richland, WA (US)

(21) Appl. No.: 11/517,718

(22) Filed: Sep. 8, 2006

(51) Int. Cl. G06F 7/00

(52) U.S. Cl. 707/101

(57) ABSTRACT

Apparatuses, data structures, and computer-implemented methods for mapping relations of items as those items occur in sets, and/or as they are associated with sets, locations and/or attributes are disclosed according to some aspects. In one embodiment, mapping comprises ingesting a corpus of data having one or more initial sets, which comprise one or more initial items, and creating a content map. The content map comprises a mapping of each initial set to one or more content lists wherein entries in a particular content list correspond to initial items in a particular initial set. The mapping of relations can further comprise defining one or more derived sets as combinations, aggregations, or segmentations of one or more of the initial sets and transforming the content map to generate a concordance.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

Effective automated information analysis can employ dynamic analyses and/or require flexibility in accessing data informative to the relationships that are relevant to the analytic task. However, limitations associated with common data structures and with typical methods for structuring data can hinder, or even prevent, automated information analysis systems and methods from accommodating multiple forms of analyses, multiple forms of data, incorporation of new or additional data, and shifts in analyses of the data (e.g., reclassification of item occurrences). Accordingly, a need exists for data structures and methods of formatting data that enable these and other dynamic analyses.

### DESCRIPTION OF DRAWINGS

Embodiments of the invention are described below with reference to the following accompanying drawings.

FIG. 1 is a block diagram depicting an embodiment of a computer-implemented method according descriptions provided elsewhere herein.

FIG. 2 is an illustration of exemplary mappings according to embodiments of the present invention.

FIG. 3 is a block diagram depicting an embodiment of an apparatus for dynamic information analysis.

### DETAILED DESCRIPTION

At least some aspects of the disclosure provide apparatuses, data structures, and computer-implemented methods for mapping relations of items as those items occur in sets, and/or as they are associated with sets, locations and/or attributes. The apparatuses, data structures, and computer-implemented methods can enable the transformation of the mappings and/or the relations within the mappings according to the attributes of the items and/or sets. Exemplary mappings can support multiple forms of classification on a single data structure by providing access to relations among items and their attributes. Furthermore, mappings can support multiple forms of analyses on a single data structure by 1) encoding within the data structure the periodicity and distribution of item occurrences within as well as across each of a plurality of data streams and information spaces, 2) providing access for methods to aggregate, segment, and/or combine relations within and across arbitrary classifications of items and their relations as encoded within the data structure, 3) enabling comparisons of analyses generated from disparate classifications, and/or 4) adding new items and relations to the existing data structure.

In one embodiment of the present invention, mapping relations of items comprises ingesting a corpus of data having one or more initial sets, which comprise one or more initial items, and creating a content map. The content map comprises a mapping of each initial set to one or more content lists, wherein entries in a particular content list correspond to initial items in a particular initial set. The mapping of relations further comprises defining one or more derived sets as combinations, aggregations, or segmentations of one or more of the initial sets and transforming the content map to generate a concordance. Derived sets are based on one or more attributes of the items, the initial sets, the derived sets, the corpus of data, or combinations thereof. The concordance comprises a mapping of items to one or more lists in the concordance (i.e., concordance list), wherein entries in a particular concordance list correspond to derived sets in which a particular item occurs.

Another embodiment encompasses an apparatus for mapping relations of items as those items occur in sets, and/or as they are associated with sets, locations and/or attributes. The apparatus can comprise processing circuitry operably connected to storage circuitry and a communications interface operably connected to the processing circuitry. The communications circuitry is configured to ingest a corpus of data comprising one or more initial sets, which comprise one or more initial items. The processing circuitry can be configured to create a content map comprising a mapping of each initial set to one or more content lists, to define one or more derived sets as combinations, aggregations, or segmentations of one or more of the initial sets, and to transform the content map to generate a concordance. Entries in a particular content list correspond to initial items in a particular initial set, while entries in a particular concordance list correspond to derived sets in which a particular item occurs. Derived sets can be based on one or more attributes of the items, the initial sets, the derived sets, the corpus of data, or combinations thereof. The content map, the concordance, the corpus of data, or combinations thereof can be stored on the storage circuitry.

Additional embodiments encompass a data structure and a computer-readable medium having computer-executable instructions for mapping relations of items as those items occur in sets, and/or as they are associated with sets, locations and/or attributes.

A corpus of data, as used herein, can refer to a domain of information that is the subject of the methods, data structures, and apparatuses described herein and that can be organized in a flexible way. The corpus of data can have a fixed volume or it can comprise streaming data. An exemplary hierarchical organization can include sets and items, wherein a corpus comprises one or more sets and each set comprises one or more items.

A set, as used herein, can refer to a portion of the corpus of data comprising the aggregate of one or more items based on one or more attributes and/or delimiters, wherein that portion can be defined by location in time, a physical or semantic space, and/or commonly shared attributes of items within the set. Accordingly, an exemplary set can be a computer-readable document or record. In one example, in the context of written natural language, an item can refer to a term and a set can refer to a document. Item occurrences, as used herein, refer to observances of items in a set. Other exemplary items can include, but are not limited to numbers, cybersecurity IP addresses, data packets, gene sequences, character patterns, and byte patterns. Accordingly, item, as used herein, can refer to a sequence of machine recognizable or human recognizable symbols and/or patterns.

An attribute can refer to a characteristic of a corpus or of any member of the corpus, including a set or an item. Exemplary attributes can be the author, language, year of publication, source of a document, an item's location in a set, an item's occurrence in a document section, the topicality of a set or item, a set delimiter, and/or the occurrence frequency of items in a set.

A content map, as used herein, can refer to a mapping of each initial set to one or more content lists wherein entries in a particular content list correspond to items in a particular initial set. In contrast, a concordance, as used herein, can refer to a mapping of each item to one or more lists in the concordance (i.e., concordance lists), wherein entries in a particular concordance list correspond to derived sets in which a particular item occurs.

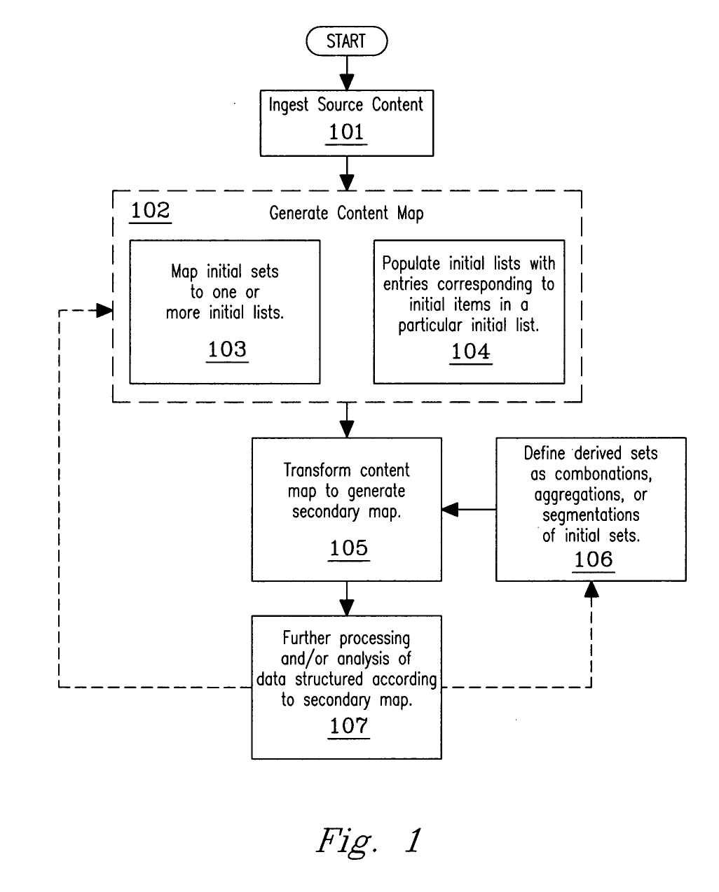

Referring to FIG. 1, a block diagram depicts an embodiment of a computer-implemented method for mapping relations of items as those items occur in sets, and/or as they are associated with sets, locations and/or attributes. Initially, a corpus of information is ingested 101 from a content source. Creation 102 of the content map can then involve mapping 103 the initial sets to one or more content lists and/or populating 104 content lists with entries corresponding to items occurring in a particular content list.

Content sources can comprise documents that are structured, unstructured, or a combination of the two. Suitable content sources are not limited to static data and can comprise streaming data. In such instances, ingestion of a corpus of data can occur in batches at predetermined intervals, or it can occur in real time. Exemplary content sources can include large text document corpora such as digital libraries, regulations and procedures, and archived reports. Additional content sources, which serve as examples, can include instant messaging transcripts, email correspondence, large sets of numerical data such as spreadsheets, IP address logs, and gene or protein sequence libraries.

Ingestion 101 can comprise identifying and recording in a content map the presence and location of items in a corpus of data. In one embodiment, the identification and recordation can occur in a single pass of the corpus. Exemplary ingestion can comprise obtaining an iterator, according to which data in the corpus will be accessed, and creating an empty content list. Within each iteration, data can be parsed into a sequence of input items. In one embodiment items parsed within an iteration are considered to belong to a single set. If known, a set delimiter may be specified before, during, or after the ingest process and will be used to further divide the content lists into additional sets. While the sequence contains more input items, the next input item is read from the sequence and can be transformed, as necessary, to a standard input item. Examples of such a transformation can include, but are not limited to, stemming or lemmatizing a text token, or reconciling a specific instance of the item to a standard representation of the item. A unique identifier is obtained for the standard input item, either by accessing an ordered item-id list or generating a unique identifier and inserting that item-id pair into the ordered list. If the item is not a set boundary in the sequence the item identifier is appended to the current content list, otherwise a unique identifier is obtained for the content list, the relation of identifier to content list is stored in the content map, and a new empty content list is created and set as the current content list. Unique identifiers for items and/or sets can be integer values, short values, or long values.

Initial sets and initial items can be delimited in the corpus of data within enclosing data structures, such as arrays, vectors, or matrices. Alternatively, they may be distinguished and/or parsed from the sequence by delimiters defined at the time of ingest. Typical delimiters of initial sets, which serve as examples, can include, but are not limited to, page breaks, paragraph breaks, etc. Typical delimiters of initial items, which serve as examples, can include, but are not limited to, terms such as words and word phrases and can be delimited by spaces and/or punctuation. Exemplary methods for parsing items and sets from a corpus of data are described in U.S. patent application Ser. No. 10/714,541 (attorney docket 13938-E) and U.S. patent application Ser. No. 11/330,792 (attorney docket 14743-E), which details are incorporated herein by reference.

The content map can be further refined if new information, not available or recognized at the time of ingest, identifies alternative set boundaries. In one embodiment, an iterator is obtained for the content map from which a set and its content list is accessible at each iteration. At each iteration, the content list is accessed as a sequence of items and if a new set boundary is encountered within that sequence, the items in the sequence occurring before the boundary are appended to the current content list and stored in the content map. A new content list is created and set as the current content list and the items in the sequence occurring after the boundary are added to the current content list.

A concordance can be generated by transforming 105 the content map, based at least in part on the classifications defined by one or more derived sets, such that items in the concordance are mapped to one or more concordance lists and entries in a particular concordance list correspond to derived sets in which a particular item occurs. Derived sets can be formed 106 by reclassifying items in the corpus of information such that a derived set comprises a combination, aggregation, or segmentation of one or more of the initial sets. Formation 106 of derived sets can be based on attributes of the items, the initial sets, the derived sets, the corpus of data, or combinations thereof.

In one embodiment, attributes, by which derived sets can be defined, can be synthesized after a corpus of data has been ingested. Accordingly, derived sets can be defined and redefined without requiring re-ingestion of the corpus of data. In one example, an attribute, such as AUTHOR, or combination of attributes, such as AUTHOR and YEAR, is selected for evaluating each of the initial content sets and an iterator is obtained with which to iterate over each initial content set. At each iteration the attribute value combination that an initial content set has for the selected attribute combination is obtained and the relation of the set identifier to the attribute value combination is stored. If the content set's attribute value combination corresponds to a previously encountered attribute value combination, then the identifier is obtained for that attribute value combination from an ordered avc-id list, otherwise a unique identifier is created for the attribute value combination and the relation is inserted into the ordered avc-id list. If the subject of further analysis is items, then a copy of the concordance is made and each content set identifier in each item's concordance list is replaced with the identifier for that set's attribute value combination as stored within the avc-id list. The resulting concordance then contains item identifiers mapped to lists of identifiers of attribute value combinations for content sets in which the item occurs. An analysis of terms mapped to lists of AUTHOR and YEAR combinations would show the patterns of term usage across authors and years.

In another embodiment, a second corpus of data can be ingested and merged into the content map and the concordance generated from a first corpus of data without re-ingesting the first corpus of data. For example, an iterator can be obtained over the corpus of data and a new content list can be created as well as a new content map. Ingestion occurs as described elsewhere herein, with the special note that the ordered item-id list used during the ingest of previous content maps is used to obtain identifiers for input items in order to ensure that similar items have the same identifier. After each set in the additional corpus of data has been read, a concordance is generated for the additional content map and the two content maps are merged. For each item identifier key in the additional concordance that is a key in the initial concordance, the entries in the list from the additional concordance are appended to the item's concordance list from the initial concordance, otherwise the item identifier and its corresponding list are added to the initial concordance as a new key value pair. When creating the content map and/or the concordance, one or more items and/or sets can be excluded.

In some instances, items can comprise aggregations or segmentations of initial items. For example, multiple items can be aggregated to a single item if it is determined that the items comprise a common phrase, based on the frequency and proximity of their occurrence in one or more sets, or that the items are synonyms based on identification that they have a common meaning, based on user guidance or access to another information system. A single item may be segmented into multiple items if a new item delimiter is identified. In one embodiment, in which multiple items can be aggregated as a single item, the list of set identifiers is replaced with a list of set identifiers in which the super-item is known to occur, some cases warrant an intersection of the list of set identifiers (phrases), others warrant the union (synonyms)

Data structured according to the concordance can be subjected to further processing and/or analysis 107. Exemplary processing can include, but is not limited to, calculating the specificity of items in the corpora based on statistical analysis of the entries in their corresponding lists, calculating an association matrix containing the pair-wise similarity of items in the concordance based on statistical analysis of the entries in their corresponding lists, generating a signature vector for each of one or more items, wherein the signature vector contains the coordinates of the item in a multi-dimensional space, generating a signature vector for each of one or more sets, content or derived, as a function of the signature vectors for the items occurring in the set. Exemplary analysis can include application of methods for automatically analyzing and characterizing the content of electronically formatted natural language-based documents. One such method includes the System for Information Discovery described in U.S. Pat. No. 6,484,168, which is incorporated herein by reference. Other analyses can be performed such as temporal analysis in which embodiments of the present invention can provide means to modify the initially ingested set boundaries following analysis to determine cohesive segments in an information stream, and correlation analysis in which the invention provides a means to aggregate item attributes into derived sets. The further processing and analysis can provide additional information and/or knowledge, which can be used to create new and/or modify existing content maps and/or concordances.

In one embodiment, the methods and data structures described herein are applied to an information analytics software library wherein information of interest is formatted according to data structures described herein using methods and apparatuses described herein. The formatted information can then be made available for analysis and processing by other components in the software library. An example of a software library includes the Deep Center Analytic Foundations (DCAF), a software library of reusable components for information analysis comprising functions for parsing items from information streams, creating and transforming mappings of items to sets and attributes, identifying features and generating feature vectors, clustering feature vectors and projecting multi-dimensional vectors to a two or three dimensional display.

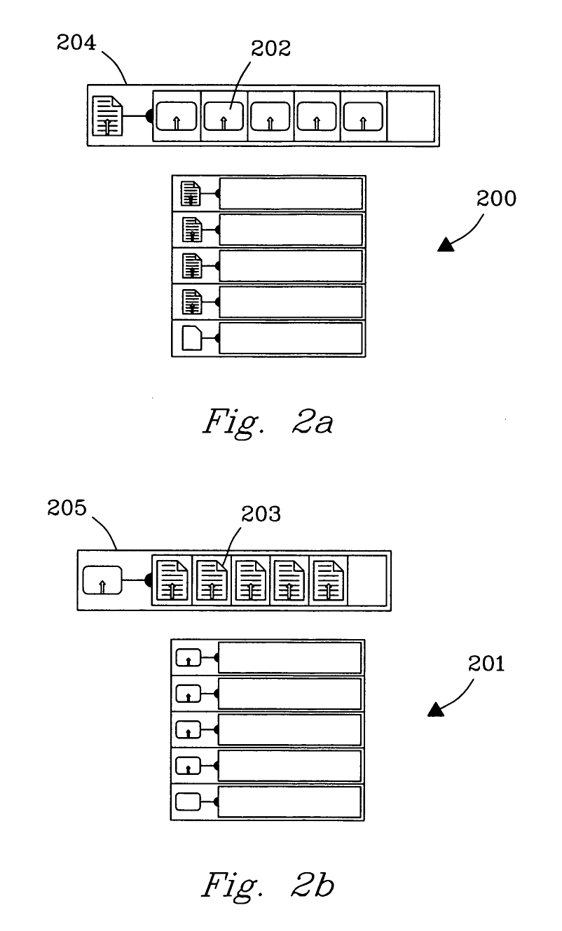

Referring to FIG. 2a, an illustration of an embodiment of a content map 200 depicts initial set identifiers as keys mapping to content lists 204 and initial item identifiers as entries 202 in the content lists. An exemplary content map can comprise documents as sets and words as items. Accordingly, the words can be mapped to documents such that each content list provides all the identifiers for the words contained in the document with which it is associated. Furthermore, the identifiers for the words can be entered in each list in the order that the words occur in the document. In some embodiments, multiple instances of a word in a document can be represented as multiple entries in the content list.

Referring to FIG. 2b, which contrasts with the data formatting represented in FIG. 2a, an illustration of an embodiment of a concordance 201 depicts item identifiers as keys mapping to concordance lists 205 and identifiers for the derived sets as entries 203 in the concordance lists. An exemplary concordance can comprise aggregated, combined, and/or segmented documents as derived sets and words as items. Accordingly, the aggregated, combined and/or segmented documents can be mapped to words such that each concordance list provides all the locations of the word with which it is associated.

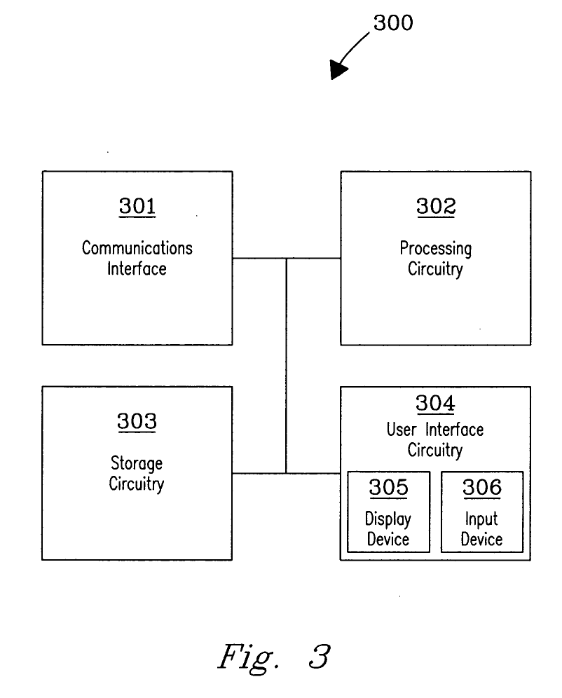

Referring to FIG. 3, an exemplary apparatus 300 for mapping relations among items occurring in sets and attributes of those items and sets is illustrated. In the depicted embodiment, the apparatus is implemented as a computing device such as a server, work station, a handheld computing device, or a personal computer, and can include a communications interface 301, processing circuitry 302, storage circuitry 303, and in some instances, a user interface 304. Other embodiments of apparatus 300 can include more, less, and/or alternative components.

The communications interface 301 is arranged to implement communications of apparatus 300 with respect to a network, the internet, an external device, a remote data store, etc. Communication interface 301 can be implemented as a network interface card, serial connection, parallel connection, USB port, SCSI host bus adapter, Firewire interface, flash memory interface, floppy disk drive, wireless networking interface, PC card interface, PCI interface, IDE interface, SATA interface, or any other suitable arrangement for communicating with respect to apparatus 300. Accordingly, communications interface 301 can be arranged, for example, to communicate information bi-directionally with respect to apparatus 300. Communicated information can include, but is not limited to, one or more attributes, part, or all, of the corpus of data, the content map, and/or the concordance.

In an exemplary embodiment, communications interface 301 can interconnect apparatus 300 to one or more persistent data stores having information stored thereon including, but not limited to, source content, content maps, attribute data for sets, attribute data for items, attribute data for corpora of data, concordances, software for further data processing, and/or software for additional information analysis. The data store can be locally attached to apparatus 300 or it can be remotely attached via a wireless and/or wired connection through communications interface 301. For example, the communications interface 301 can facilitate access and retrieval of information from one or more web servers serving documents containing structured and/or unstructured data that can be ingested, mapped, and/or analyzed according to embodiments described elsewhere herein.

In another example, communications interface 301 can interconnect apparatus 300 to a second apparatus comprising a client device operated by a remote user. Apparatus 300 can ingest and map corpora of information according to embodiments described elsewhere herein and can communicate mapped data, which can be further analyzed and refined by additional information analytics software, to the second apparatus. Input from the remote user can be received through communications interface 300.

In another embodiment, processing circuitry 302 is arranged to execute computer-readable instruction, process data, control data access and storage, issue commands, and control other desired operations. More specifically, processing circuitry 302 can operate to create a content map comprising a mapping of each initial set to one or more content lists, wherein entries in a particular content list correspond to initial items in a particular initial set. It can also operate to define one or more derived sets as aggregations or segmentations of one or more of the initial sets, wherein derived sets are based on one or more attributes of the items, the initial sets, the derived sets, the corpus of data, or combinations thereof. Furthermore, processing circuitry 302 can operate to transform the content map to generate a concordance comprising a mapping of items to one or more concordance lists, wherein entries in a particular concordance list correspond to derived sets in which a particular item occurs.

Processing circuitry 302 can comprise circuitry configured to implement desired programming provided by appropriate media in at least one embodiment. For example, the processing circuitry can be implemented as one or more of a processor, and/or other structure, configured to execute computer-executable instructions including, but not limited to, software, middleware, and/or firmware instructions, and/or hardware circuitry. Exemplary embodiments of processing circuitry can include hardware logic, PGA, FPGA, ASIC, state machines, and/or other structures alone or in combination with a processor. The examples of processing circuitry described herein are for illustration and other configurations are both possible and appropriate.

Storage circuitry 303 can be configured to store programming such as executable code or instructions (e.g., software, middleware, and/or firmware), electronic data (e.g., data files, databases, data items, etc.), and/or other computer-readable information and can include, but is not limited to, processor-usable media. Exemplary programming can include, but is not limited to, software components contained in an information analytics software library and to programming configured to cause apparatus 300 to map the relations among items occurring in sets and attributes of those items and sets. Processor-usable media can include, but is not limited to, any computer program product, data store, or article of manufacture that can contain, store, or maintain programming, data, and/or digital information for use by, or in connection with, an instruction execution system including the processing circuitry 302 in the exemplary embodiments described herein. Generally, exemplary processor-usable media can refer to electronic, magnetic, optical, electromagnetic, infrared, or semiconductor media. More specifically, examples of processor-usable media can include, but are not limited to floppy diskettes, zip disks, hard drives, random access memory, compact discs, and digital versatile discs.

At least some embodiments or aspects described herein can be implemented using programming configured to control appropriate processing circuitry and stored within appropriate storage circuitry and/or communicated via a network or via other transmission media. For example, programming can be provided via appropriate media, which can include articles of manufacture, and/or embodied within a data signal (e.g., modulated carrier waves, data packets, digital representations, etc.) communicated via an appropriate transmission medium. Such a transmission medium can include a communication network (e.g., the internet and/or a private network), wired electrical connection, optical connection, and/or electromagnetic energy, for example, via a communications interface, or provided using other appropriate communication structures or media. Exemplary programming, including processor-usable code, can be communicated as a data signal embodied in a carrier wave, in but one example.

User interface 304 can be configured to interact with a user and/or administrator, including conveying information to the user (e.g., displaying data for observation by the user, audibly communicating data to the user, etc.) and/or receiving inputs from the user (e.g., tactile inputs, voice instructions, etc.). For example, the user interface can receive input from a human information analyst regarding parameters for defining derived sets. The user interface can also display mapping results for consideration by the information analyst. Accordingly, in one embodiment, the user interface 304 can include a display device 305 configured to depict visual information, and a keyboard, mouse and/or other input device 306. Examples of a display device include cathode ray tubes and LCDs.

The embodiment shown in FIG. 3 can be an integrated unit configured to map relations among items occurring in sets and attributes of those items and sets. Other configurations are possible, wherein apparatus 300 is configured as a networked server and one or more clients are configured to access the processing circuitry and/or storage circuitry for activities including, but not limited to, transmitting or receiving data structured according to embodiments described elsewhere herein, viewing or modifying content maps, defining derived sets, and analyzing information structured according to data structures described elsewhere herein.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A computer-implemented method comprising:
ingesting a corpus of data comprising one or more initial sets, which comprise one or more initial items;
creating a content map comprising a mapping of each initial set to one or more content lists, wherein entries in a particular content list correspond to initial items in a particular initial set;
defining one or more derived sets as combinations, aggregations, segmentations, or transformations of one or more of the initial sets, wherein derived sets are based on one or more attributes of the items, the initial sets, the derived sets, the corpus of data, or combinations thereof; and
transforming the content map to generate a concordance comprising a mapping of items to one or more concordance lists, wherein entries in a particular concordance list correspond to derived sets in which a particular item occurs.

2. The method as recited in claim 1, wherein one or more items in the concordance comprise an aggregation or segmentation of one or more initial items.

3. The method as recited in claim 1, wherein one or more of the attributes are synthesized after the corpus is ingested.

4. The method as recited in claim 1, further comprising ingesting an additional corpus of data and merging the content of the additional corpus of data into the concordance without reingesting a prior corpus of data.

5. The method as recited in claim 1, wherein the presence and locations of unique items in the corpus of data are identified and recorded in a single pass.

6. The method as recited in claim 1, wherein entries in the content lists of the content map represent items in the order in which they occur in the corpus of data.

7. The method as recited in claim 1, wherein multiple occurrences of a particular initial item in a particular initial set are represented by multiple entries in the content list associated with the particular initial set.

8. The method as recited in claim 1, further comprising representing items, sets, or both as integer values, short values, or long values, or combinations thereof.

9. The method as recited in claim 1, wherein the corpus of data comprises text sources and the initial sets comprise documents containing text.

10. The method as recited in claim 1, further comprising generating a signature vector for each of one or more items, wherein the signature vector uniquely identifies the item based on attributes of the item.

11. The method as recited in claim 1, further comprising specifying one or more items, sets, or a combination thereof, to be excluded from the content map, the concordance, or both.

12. The method as recited in claim 1, wherein the corpus of data comprises streaming data.

13. A computer-readable medium having computer-executable instructions for performing the method as recited in claim 1.

14. A data structure for mapping relations among items occurring in sets and attributes of those items and sets, the data structure being stored on a computer-readable medium and comprising a mapping of the items to one or more lists, wherein entries in a particular list correspond to derived sets in which a particular item occurs and one or more derived sets are combinations, aggregations, or segmentations of initial sets based on one or more attributes of the items, the initial sets, the derived sets, the corpus of data, or combinations thereof.

15. The data structure as recited in claim 14, wherein one or more of the items are an aggregation or segmentation of one or more initial items.

16. The data structure as recited in claim 14, wherein the data structure retains the relative positions of items, sets, or both as observed within each of a plurality of data corpora.

17. The data structure as recited in claim 14, wherein items, sets, or both are represented as integer values, short values, long values, or combinations thereof.

18. An apparatus for mapping relations among items occurring in sets and attributes of those items and sets comprising:
a. a communications interface operably connected to processing circuitry and configured to ingest a corpus of data comprising one or more initial sets, which comprise one or more initial items;
b. processing circuitry operably connected to storage circuitry and configured to:
i. create a content map comprising a mapping of each initial set to one or more content lists, wherein entries in a particular content list correspond to initial items in a particular initial set;
ii. define one or more derived sets as aggregations or segmentations of one or more of the initial sets, wherein derived sets are based on one or more attributes of the items, the initial sets, the derived sets, the corpus of data, or combinations thereof; and
iii. transform the content map to generate a concordance comprising a mapping of items to one or more concordance lists, wherein entries in a particular concordance list correspond to derived sets in which a particular items occurs;
wherein the content map, the concordance, the corpus of data, or combinations thereof are stored on the storage circuitry.

19. The apparatus as recited in claim 18, configured to communicate bi-directionally part or all of the corpus of data, the content map, one or more attributes, the concordance, or combinations thereof with a separate computing device through the communications interface

20. The apparatus as recited in claim 18, further comprising a library of information analysis software stored on the storage circuitry, accessed through the communications interface, or both.

21. The apparatus as recited in claim 20, wherein the information analysis software operates on data structured according to the concordance.
